(19) United States
(12) Patent Application Publication
(10) Pub. No.: US 2026/0258915 A1
(43) Pub. Date: Sep. 3, 2026

(54) APPARATUS, METHOD, AND SYSTEM FOR RETROFITTING A LIGHTING SYSTEM WITH UPLIGHTING

(71) Applicant: Musco Corporation, Oskaloosa, IA (US)

(72) Inventors: Luke C. McKee, Oskaloosa, IA (US); Chris P. Lickiss, Newton, IA (US); Philip D. Hol, New Sharon, IA (US); Joel D. DeBoef, New Sharon, IA (US)

(73) Assignee: Musco Corporation, Oskaloosa, IA (US)

(21) Appl. No.: 18/875,230

(22) PCT Filed: Jul. 15, 2024
(86) PCT No.: PCT/US24/38011

§ 371 Date: Dec. 16, 2024

Related U.S. Application Data
(60) Provisional application No. 63/578,481, filed on Aug. 24, 2023.

(51) Int. Cl. F21K 9/238; F21K 9/69; F21V 5/00; F21V 5/04; F21V 21/116; F21V 21/26; F21V 23/00; F21V 29/76; F21V 31/00; F21W 131/10; F21Y 103/10

(52) U.S. Cl. CPC F21K 9/238; F21K 9/69; F21V 5/007; F21V 5/04; F21V 21/116; F21V 21/26; F21V 23/008; F21V 29/763; F21V 31/005; F21W 2131/10; F21Y 2103/10

(57) ABSTRACT

A self-contained luminaire, driver, and attachment assembly has at least a first luminaire, an attachment beam defining a driver receiving cavity, and a driver assembly configured to fit within the driver receiving cavity. The first luminaire includes a single row of light emitting diodes, and at least a first set of optics that is configured to provide a horizontal spread and a vertical spread of at least a portion of light emitted from the single row of light emitting diodes. The vertical spread of light is bounced off a reflective visor.

### CROSS-REFERENCE TO RELATED APPLICATIONS

This application is a National Stage Application claiming priority to and the benefit of International Patent Application No. PCT/US2024/038011, filed Jul. 15, 2024, which is related to and claims benefit of U.S. Provisional Application Ser. No. 63/578,481, filed Aug. 24, 2023, and the contents of each is hereby incorporated herein by reference in their entireties.

### TECHNICAL FIELD

The present disclosure generally relates to improvements in luminaire design which relate to the sharpness of beam cutoff. More specifically, the present invention relates to providing an LED luminaire for baseball uplighting (and for e.g., other wide-area uses, rail and shipping yards, parking lots, and building illumination), said luminaire having a sharp cutoff of light at the lower edge of the composite beam projected therefrom, which reduces the angle over which light projected from the luminaire transitions from “full light” to “no light.” This allows a relatively high level of illumination in the vertical space above a field with a sharp cutoff immediately above, but relatively close to, players on a field. The present disclosure also relates to a luminaire that may require fewer light sources that generate less heat, thereby reducing cost.

### BACKGROUND

Lighting baseball fields requires both illuminating the playing surface of the field and providing “uplighting” (i.e., light to the aerial space above and/or proximate the field). Field illumination is typically provided in accordance with at least a minimum accepted standard, such as is found in RP-6-15 of the Illuminating Engineering Society (IES). U.S. Pat. No. 10,267,491 discusses the necessity of consideration of aerial lighting levels.

It is also known in the lighting industry that lighting that is otherwise satisfactory and meets illumination standards for field lighting can still pose problems when considering uplighting. As discussed in U.S. Pat. No. 7,976,198, light sources can cause glare and reduce playability for some of the players due to the mounting locations and aiming angles of the light sources. For example, a luminaire that provides uplighting but causes reflection on surfaces near the luminaire or internal glow from the luminaire can cause unwanted glare in the eyes of the batter or other players. This glare can obscure the ball and reduce the player's ability to visually track it. U.S. Pat. Nos. 7,976,198 and 9,402,292, both provide a discussion of some of the considerations that go into determining when uplight is needed, when glare may be perceived, how to adequately design a lighting system to provide uplight while mitigating glare, and the like.

Still further, it is well known in the art of lighting design that improving lighting and reducing cost are primary drivers and can lead to many excellent designs optimized for a specific primary function, but sometimes to the detriment of a secondary function. For example, older designs with less control tended to provide adequate lighting of an aerial space (albeit typically with less control over perceived glare) because visors, etc. were not as precise—particularly for HID lighting. Contrarily, newer designs such as newer LED luminaires exhibit enhanced beam control and while well suited for target areas, no longer have sufficient uncontrolled light that could be used for aerial lighting. This is in addition to the fact that there are still significant areas (older or newer technology) which are lacking in adequate progress. For example, there has been little progress in reducing the number of pole or light mounting locations for wide area lighting applications—progress which could lead to reduced cost.

Therefore, a one-for-one replacement approach in the residential lighting retrofit market such as taking an old light source out and placing a new light source in with no other changes required is impractical for the specialized lighting retrofit market.

Some luminaries are also unsuitable for uplighting from a low-or mid-mounted position, as the multiple rows of LEDs create problems by making it very difficult to create a sharp cutoff of light near the edge of the composite beam.

It is thus desirable to provide an apparatus, method, and system for retrofitting existing lighting systems to provide uplight with desired attributes such as glare control at a reduced cost.

### SUMMARY

A self-contained luminaire, driver, and attachment assembly according to an embodiment of the present disclosure may comprise at least a first luminaire, an attachment beam defining a driver receiving cavity. And a driver assembly configured to fit within the driver receiving cavity. The first luminaire may comprise a single row of light emitting diodes, and at least a first set of optics that is configured to provide a horizontal spread and a vertical spread of at least a portion of light emitted from the single row of light emitting diodes.

A LED luminaire according to another embodiment of the present disclosure may comprise a rear fixture plate with a heat sink connected to the rear fixture plate, a LED board configured to connect to the rear fixture plate, at least a first optics holder, at least a first optics member configured to be held adjacent the LED board by the first optics holder, a window, and a front frame configured to trap the window, the first optics member, the first optics holder, and LED board adjacent the rear fixture plate. The LED board may include a single row of LEDs and the heat sink may include a predetermined number of heat sink fins, the LED board may include a predetermined number of LEDs, and a ratio of the predetermined number of LEDs to the predetermined number of heat sink fins ranges from 2.0 to 3.0. In specific embodiments, this ratio may range from 2.4 to 2.6 (e.g., about 2.5).

An optics member according to yet another embodiment of the present disclosure may comprise a center plate portion, a forward lens portion defining an upper undulating boundary and a lower undulating boundary, and a rearward LED receiving portion including a plurality of cones each defining an elongated cavity. The forward lens portions may be angled away from the center plate portion to redirect light upward relative to the plurality of cones.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the disclosure. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 illustrates a prior art system of an exterior lighting system that includes poles with LED (light emitting diodes) luminaires attached thereto for lighting a sports field, and the area above the sports field. As shown, a baseball field or other sports field may be illuminated by the prior art system. It is contemplated that some prior art systems may employ HID (high intensity discharge) lamps in other applications.

FIG. 2 depicts a prior art uplight luminaire that may be attached to one or more of the poles of FIG. 1.

FIG. 3 is a perspective view of a quad optic member used in the luminaire of FIG. 2 shown in isolation.

FIG. 4 is a front perspective view of a single and a double uplight luminaire and crossarm assemblies that may be attached to a pole according to various embodiments of the present disclosure.

FIG. 5 is a rear perspective view of the assemblies of FIG. 4 with the vertical beam members removed, revealing LED drive assemblies that are mounted internally in the vertical beam members for powering the uplight luminaires.

FIG. 6 is an enlarged front perspective view of the single uplight luminaire and crossarm assembly of FIG. 5 with the window removed, revealing five sets of optics, and optic holders covering the LEDs mounted on a LED board.

FIG. 7 illustrates the single uplight luminaire of FIG. 6 with the optics removed, revealing the orifices designed to receive the rear portion of the optics and the LEDs themselves.

FIG. 8 depicts the single uplight luminaire of FIG. 7 with the optics holders removed. The LED board can be clearly seen.

FIG. 9 is a front perspective view of the LED board, a single instance of an optics holder, and a single instance of an optics member shown in isolation from the single uplight luminaire of FIG. 6.

FIG. 10 is an enlarged front perspective showing the optics member and optics holder of FIG. 9 more clearly.

FIG. 11 is a top sectioned view of FIG. 10.

FIG. 12 is a front perspective view of the optics member of FIG. 10 shown by itself.

FIG. 13 is a front view of the optics member of FIG. 12.

FIG. 14 is a rear perspective view of the optics member of FIG. 12.

FIG. 15 is a rear view of the optics member of FIG. 14.

FIG. 16 is right side view of the optics member of FIG. 12.

FIG. 17 is a top view of the optics member of FIG. 14.

FIG. 18 is an enlarged view of the center lens portion of the optics member of FIG. 17.

FIG. 19 is a front perspective view of the optics holder of FIG. 10 shown in isolation.

FIG. 20 is a rear perspective view of the optics holder of FIG. 19.

FIG. 21 is a side schematic view showing an optical model of the new optical member, illustrating how it bends refracts light downward toward the reflective visor that reflects the light upwardly.

FIG. 22 is a side view showing more generally how the new optical member bounces light off the reflective visor to provide uplight.

FIG. 23 shows various baseball trajectories indicating that the maximum angle needed for uplight from an uplight luminaire at 25 feet above the ground is about 45.0 degrees from the horizontal plane.

FIG. 24 illustrates the vertical and horizontal beam spread achievable using the new optical member.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

To further an understanding of the present disclosure, specific exemplary embodiments according to the present disclosure will be described in detail. Frequent mention will be made in this description to the drawings. Reference numbers will be used to indicate certain parts in the drawings. Unless otherwise stated, the same reference numbers will be used to indicate the same parts throughout the drawings. Further, similar reference numbers (e.g., 702, 802, 902, 1002, 1102) will be used to indicate similar parts or functionality between embodiments. Reference numbers followed by letters (e.g., 100, 100a) may denote the same or similar features that may be symmetrical to each other, etc.

Regarding terminology, terms such as “means”, “devices”, “elements”, “parts”, “portions”, “structure”, “components”, and “members” may be used interchangeably herein, in the singular or plural, by way of convenience and not depart from aspects of the present disclosure, nor place limiting effects on aspects of the present disclosure unless explicitly stated otherwise.

Also, terms such as “having”, “including”, “with”, etc. or forms thereof are to be interpreted as being open, not limiting the parts of a structure that may be added to that structure. The term “generally linear”, “linear array” or forms thereof are to be interpreted to include arrays of items such as LEDs that follow a sweep path that is at least partially straight or is slightly curved so that a tangent at one end of the array forms an angle with a tangent at another end of the array that is less than 40 degrees.

Also, a number of terms have been used for reasons of convenience or explanation that should not be considered limiting beyond that which is presented herein. For example, the terms “luminaire(s)” and “fixture(s)” are used interchangeably herein, as they often are in the lighting industry. Neither term is intended to purport any specific limitations beyond those which are described herein.

As another example, reference is given herein to “ballast(s)” and “driver(s)”; while both are power regulating means for lighting technology, the former is used herein with respect to HID light sources and the latter is used with respect to LED light sources. However, it should be noted that where aspects of the disclosure applied to other kinds of light source (e.g., laser diodes), the corresponding terminology for the power regulating means may differ. It should be generally understood that various embodiments of the present disclosure are directed to lighting system retrofits and so any specific reference to a type of light source or power regulating means should be given its broadest interpretation.

For example, a ballast could encompass magnetic ballasts, electronic ballasts, and generally any AC power conditioning means, whereas a driver could encompass generic drivers (i.e., simple DC power conditioning means), so-called smart drivers (i.e., complex DC power conditioning means that may include programmable features, self-healing components, active feedback loops, etc.), or something in between. All of the aforementioned possibilities are contemplated to be within the scope of the present disclosure.

Lastly regarding terminology, reference may be given herein to terms such as “ray(s)”, “beam(s)”, “beam pattern(s)”, “beam shape(s)”, “composite beam(s)”, “beam design(s)”, or the like. All of these terms make reference to light projected from a lighting fixture. It is to be understood that the nature of light is complex and that the terms herein may generally describe the shape of light as projected onto a target area from a lighting fixture, or the intensity in an aerial space above a target area, or the general direction of light as it leaves a luminaire, or the like. While specific descriptions and illustrations are provided herein, it is to be understood that none of these terms, descriptions, or illustrations are to be considered all-encompassing of lighting concerns one may encounter during a retrofit situation; however, it should also be noted that all are commonly known terms and understood well in the art of lighting.

### Overview

As previously stated herein, the present disclosure is directed to lighting system retrofits. More specifically, retrofits for specialized lighting systems are disclosed.

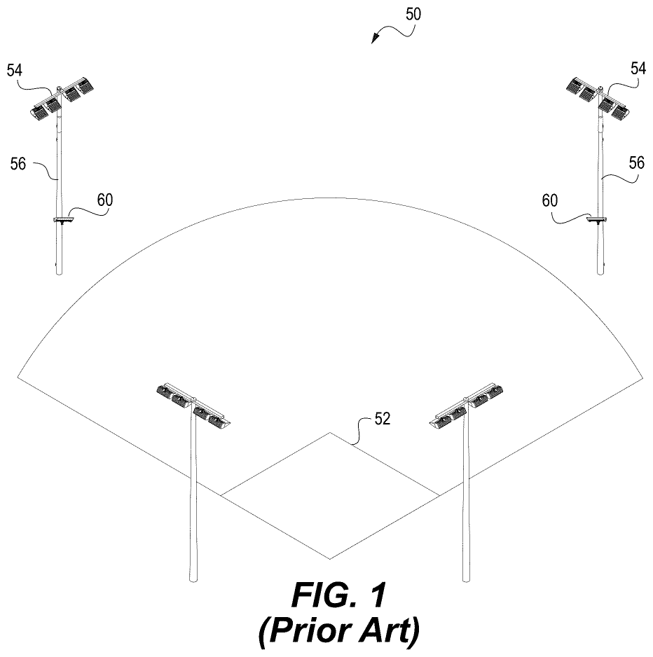

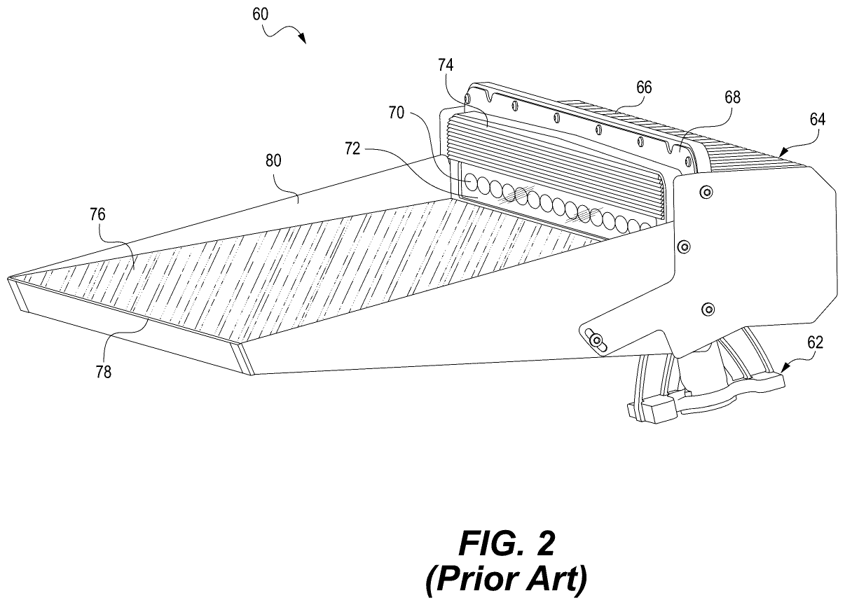

One such specialized lighting system is illustrated in FIGS. 1 and 2. Here, a sports lighting system 50 designed to illuminate a sports field 52 and some portion of the aerial space above the field is depicted. As can be seen from FIG. 1, downlight is provided by LED luminaires 54. It is contemplated that other systems may employ HID (high intensity discharge) lamps for downlight. In either case, uplights may not have been originally provided and it may be desirable to provide uplight at a reasonable cost. In some lighting systems as depicted in FIG. 1, one or more LED uplight luminaires 60 may have already supplied (may be attached to poles 56).

Such a LED uplight luminaire 60 is shown by itself in FIG. 2. The luminaire 60 is attached to a crossarm (not clearly shown in FIGS. 1 and 2) extending from a pole 56 via an adjustable armature 62 (e.g., a knuckle) that is attached to heat sink 64 having a high density of heat fins 66 (e.g., 50 heat fins) for dissipating heat generated by powering the LEDs. The heat sink 64 in turn is attached to a rear fixture plate 68. LEDs 70 (80 model XP-L2 LEDs available from Cree, Inc. in Durham, N.C. may be employed arranged in compact arrays) are shown covered by a transparent window 72 that are trapped onto the rear fixture plate 68 via fastening or the like. Ribs 74 or blackened portions aid in reducing internal glow, perceived glare, and/or back light. A reflective surface 76 is provided on the visor to help provide uplight, while the front edge 78 of the visor helps to provide light cutoff. Side visor portions 80 help provide glare control.

In FIGS. 1 and 2, it is to be understood that wiring is internally routed through pole 56, into a crossarm, through adjustable armature 62, and to each luminaire 54, 60 that may be arranged in an array. Alternatively, the wiring may be routed externally relative to the beams, poles, crossarms, etc. such as through conduit from the power source to the luminaires including uplights, etc. This is adequate description of a specialized lighting system which may be retrofitted according to and benefit from aspects according to the present disclosure, though additional background information is available in U.S. Pat. Nos. 6,250,596, 7,600,901, 8,163,993, 8,337,058, and 8,770,796, etc.

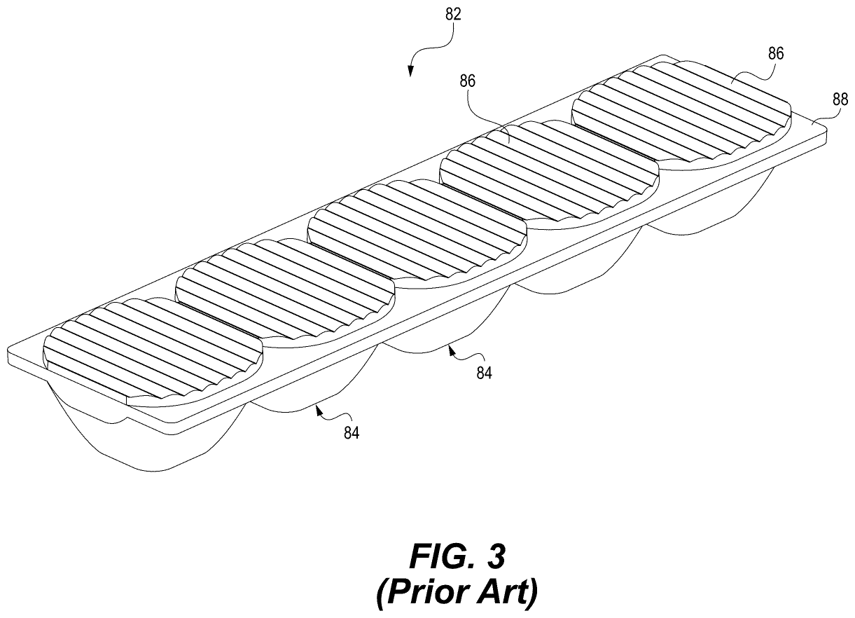

FIG. 3 shows a quad optic member 82, so called, since the rear cones 84 have cavities (not shown) for receiving four LEDs. The forward lens portion 86 is essentially parallel to the center plate portion 88. This increases the cost of the luminaire as will be discussed more thoroughly later herein.

The exemplary embodiments envision systems, apparatuses and methods provide for upgrading lighting systems in a manner which provide adequate uplight while reducing costs. These exemplary embodiments, utilizing aspects of the generalized examples already described, will now be described herein.

### Self-Contained Luminaire, Driver, and Attachment Assembly

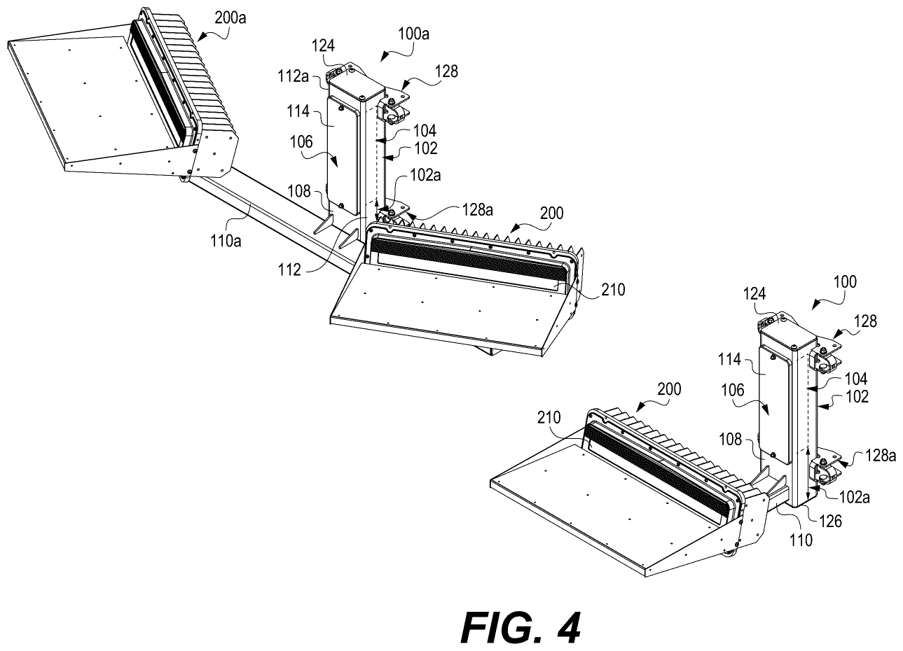

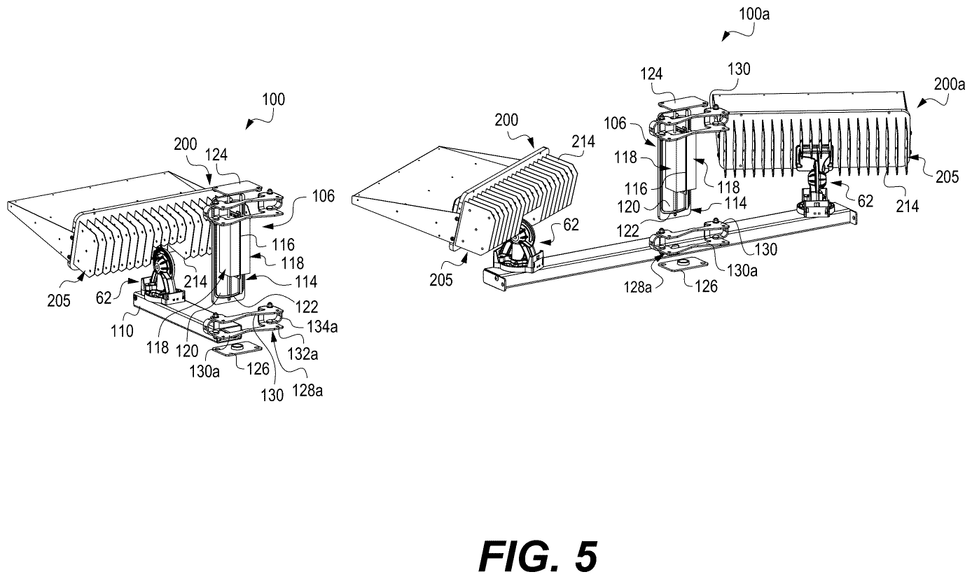

A self-contained luminaire, driver, and attachment assembly 100, 100a configured according to an embodiment of the present disclosure will now be discussed starting with FIGS. 4 and 5.

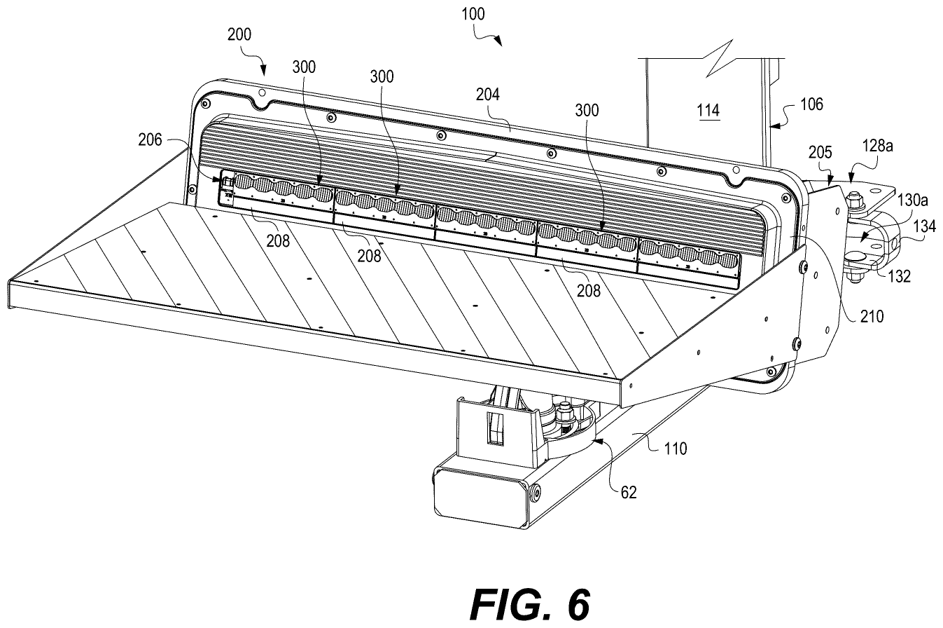

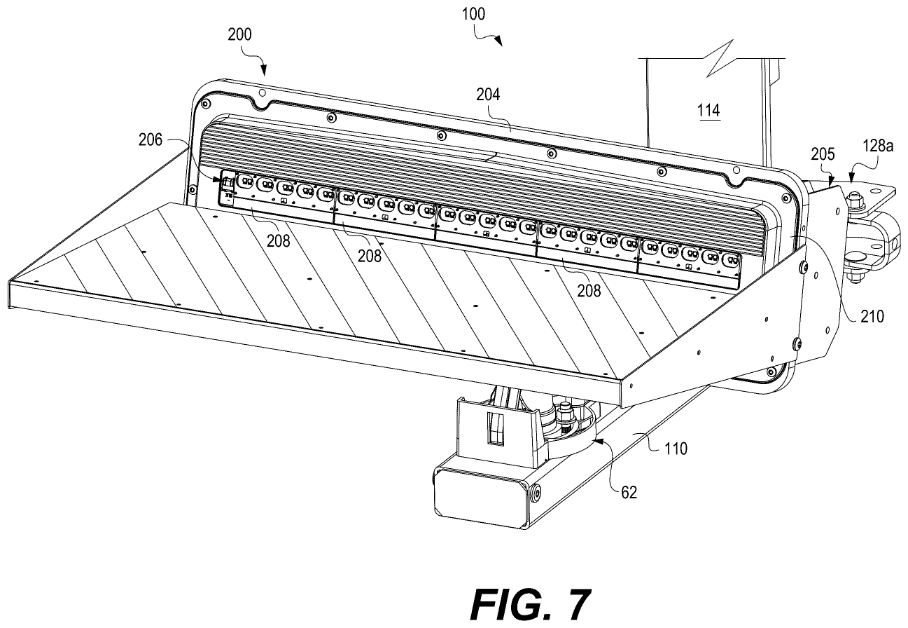

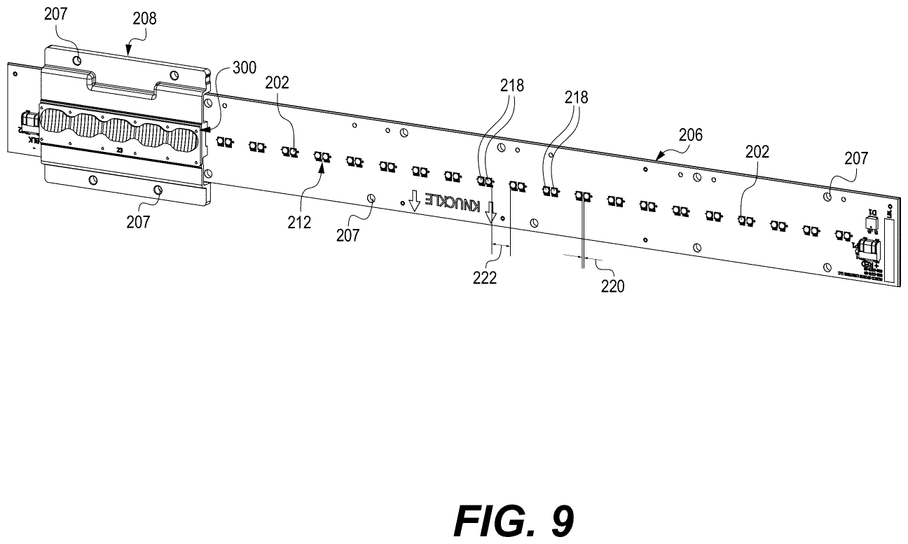

Such an assembly 100, 100a may comprise at least a first luminaire 200, an attachment beam 102 defining a driver receiving cavity 104, and a driver assembly 106 that is configured to fit within the driver receiving cavity 104. The first luminaire 200 comprises a single row of light emitting diodes 202 (see FIG. 9, and at least a first set of optics (see optics member 300 in FIG. 6) that is configured to provide a horizontal spread and a vertical spread of at least a portion of light emitted from the single row of light emitting diodes 202 in a manner that will be described in further detail later herein.

Still referring to FIGS. 4 and 5, the attachment beam 102 may take the form of a vertical beam 102a that defines a front face 108 that defines the driver receiving cavity 104. Other configurations are contemplated to be within the scope of the present disclosure. For example, the attachment beam may extend horizontally, and its top face may define the driver receiving cavity, etc. For assembly 100 (may be referred to as a single self-contained luminaire, driver, and attachment assembly), it may comprise a shorter crossarm 110 that extends perpendicularly to the front face 108, and the first luminaire 200 may be a single luminaire that is disposed in front of the front face 108.

For assembly 100a (may be referred to as a double self-contained luminaire, driver, and attachment assembly), a longer crossarm 110a may be provided that extends along a direction that is parallel to the front face 108 of the vertical beam 102a past the front face 108 on a first side 112, and on a second side 112a. Other lengths and configurations are possible for the crossarms such as diagonal, etc. The first luminaire 200 may be disposed at a first end of the longer crossarm 110a, and a second luminaire 200a (may be similarly or identically configured as the first luminaire 200) may disposed at a second end of the longer crossarm 110a.

As best seen in FIG. 6, an adjustable armature 62 (e.g., a knuckle) may connect the first luminaire 200 and/or the second luminaire 200a to the shorter crossarm 110, and the longer crossarm 110a. The driver assembly 106 may include a front mounting plate 114 that is configured to be mounted to the front face 108 (see FIG. 3) of the vertical beam 102a, a driver attachment plate 116 extending perpendicularly from a rear surface of the front mounting plate 114, and at least a first driver 118 attached to the driver attachment plate 116. The rear surface of the front mounting plate 114 may define a seal receiving groove 120 with a seal 122 disposed therein to provide a watertight seal between the plate and the vertical beam.

While two drivers are shown for assembly 100, only one would actually be necessary since there is only one luminaire. An exemplary driver that could be used includes an INVENTRONICS model ESM-240S150DT (275 Watts) driver, etc. The various plates of the driver assembly may be made from steel, aluminum, etc.

Referring now to FIG. 4 thru 6, the assembly 100, 100a may further comprise a top plate 124 capping off the vertical beam 102a, and a bottom wire access plate 126 disposed at the bottom of the vertical beam 102a for providing power to the luminaires in a manner previously discussed herein with reference to FIGS. 1 and 2.

Also, a top mounting bracket assembly 128, and a bottom mounting bracket assembly 128a may be attached to the vertical beam 102a for allowing the self-contained luminaire, driver, and attachment assembly 100, 100a to be readily attached to poles of lighting systems in the field. In some embodiments of the present disclosure, the top mounting bracket assembly 128, and the bottom mounting bracket assembly 128a are identically configured (within a reasonable manufacturing tolerance of +/−0.010 of an inch), but not necessarily so.

Looking at FIGS. 5 and 6 together, the bottom mounting bracket assembly 128a may include a top mounting plate 130 including a first mounting ear 132, and a second mounting ear 132a (ears may be symmetrical about a vertical plane). Similarly, a bottom mounting plate 130a may be provided that is identically configured as the top mounting plate 130.

A first side U-shaped bracket 134 may be provided connecting the top mounting plate to the bottom mounting plate at the first mounting ear, and a second side U-shaped bracket 134a connecting the top mounting plate to the bottom mounting plate at the second mounting ear. Though not shown, it is to be understood that the top mounting bracket assembly 128 and the bottom mounting bracket assembly 128a may be used with a pair of sheet metal straps that are apertured to register with apertures of the side U-shaped brackets. Fasteners and nuts attached the sheet metal straps to the side U-shaped brackets that are rotated to slacken or tighten the sheet metal straps about the pole for holding the self-contained luminaire, driver, and attachment assembly 100, 100a to the pole in a fixed manner.

### Luminaire

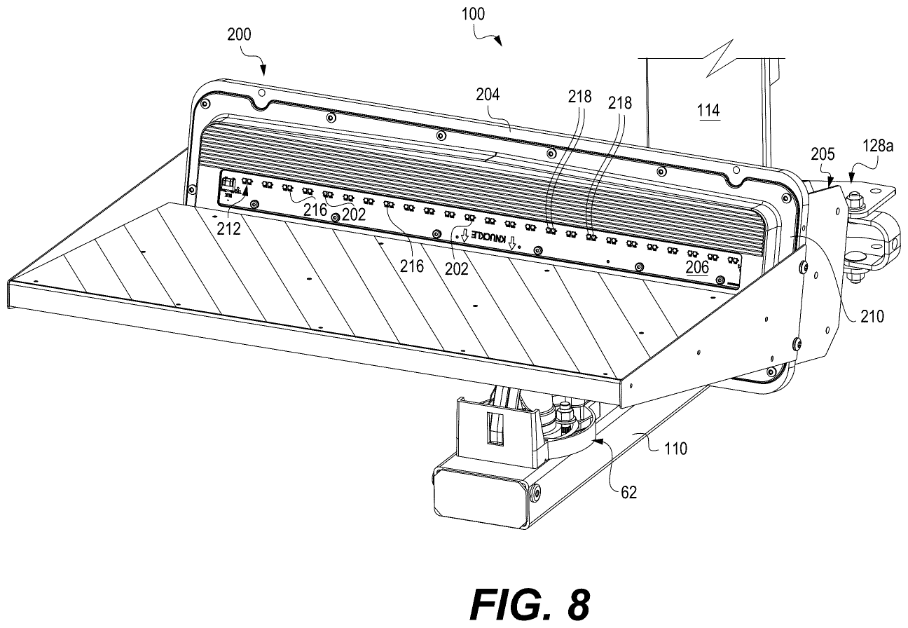

Focusing on FIG. 6 thru 8, a LED luminaire 200 as discussed previously herein that may replace the previous uplight luminaire (having many or all of the same features) discussed herein regarding FIGS. 1 and 2 will now be discussed. The LED luminaire 200 may comprise a rear fixture plate 204 with a heat sink 205 connected to the rear fixture plate 204, a LED board 206 (see FIGS. 8 and 9) that is configured to connect to the rear fixture plate 204 (e.g., via fastener receiving holes 207), at least a first optics holder 208, at least a first optics member 300 configured to be held adjacent the LED board 206 by the first optics holder 208, a window 210 (see FIG. 4), and a front frame 210 configured to trap the window 210, the first optics member 300, the first optics holder 208, and LED board 206 adjacent the rear fixture plate 204.

Looking at FIGS. 5 and 8 together, the LED board 206 may include a single row 212 of LEDs and the heat sink 205 may include a predetermined number of heat sink fins 214. More particularly, the LED board 206 includes a predetermined number of LEDs 216, and a ratio of the predetermined number of LEDs 216 to the predetermined number of heat sink fins 214 ranges from 2.0 to 3.0 (e.g., 2.5). For the specific embodiment shown in FIGS. 5 and 8, the LED board includes 50 LEDs (may be the same type of LEDs discussed earlier herein) or less, and the heat sink includes 20 heat fins or less. The optics that will be discussed herein momentarily allow fewer LEDs to be used, resulting in a decreased cost, also necessitating fewer heat fins since there is less heat to dissipate, further reducing costs. Other ratios, number of LEDs and heat fins may be employed in other embodiments of the present disclosure depending on the application, etc.

As best seen in FIG. 9, the LED board 206 includes a plurality of paired LEDS 218, that are spaced away from each other by a minimum distance 220 of 0.060 of an inch, and each of the plurality of paired LEDs are spaced away from each other by a maximum distance 222 of 0.518 of an inch. These distances may be different in other embodiments of the present disclosure. These distances provide for proper optics and heat dissipation in different embodiments of the present disclosure.

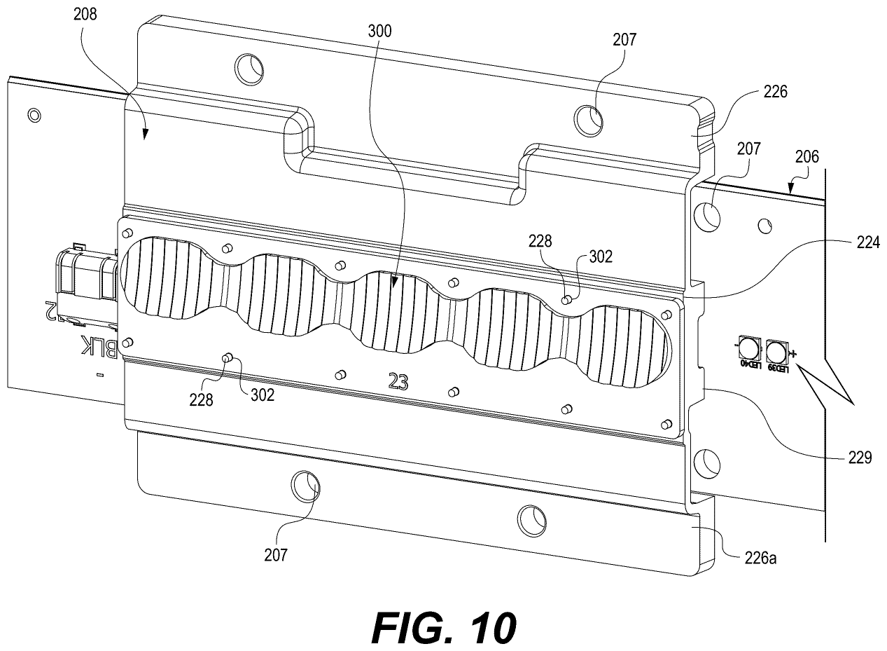

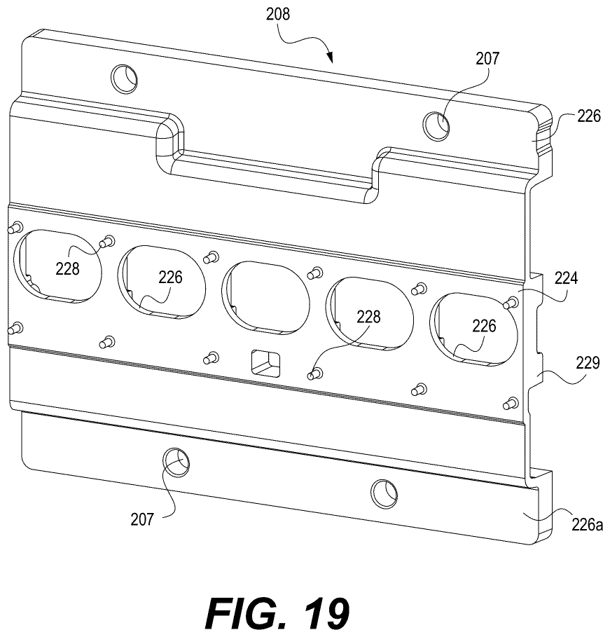

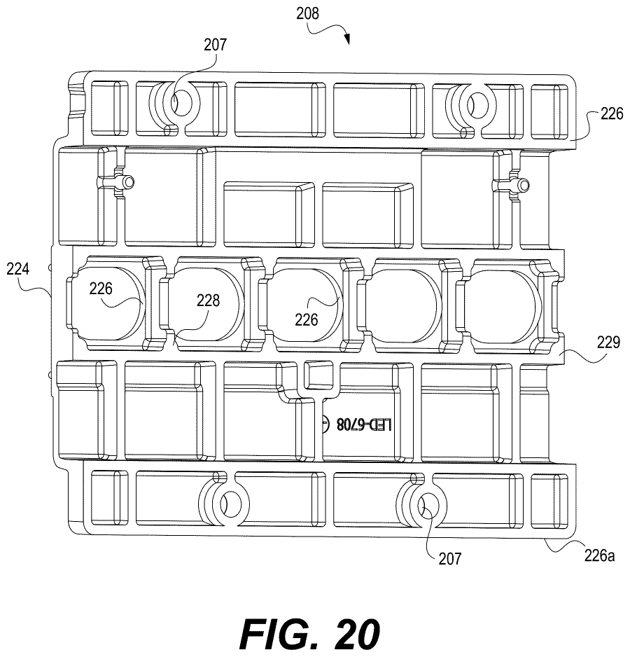

Turning now to FIGS. 10, 19, and 20, it can be observed that the optics holder 208 includes a center raised section 224 defining a plurality of lens receiving apertures 226 and a plurality of LED and optic surrounding ribs 229. Also, the optics holder has a first lower section 226 configured to be attached to the rear fixture plate via fastener receiving holes 207. Two such lower sections 226, 226a may be provided. A plurality of posts 228 may extend forwardly from the center raised section 224 that fit into post receiving apertures 302 of the optics member 300, holding it into place before the window and front frame are assembled on top of it. The posts may be heat stake pins, but not necessarily so. The optics holder may be made from a suitable thermoplastic.

### Optics Member

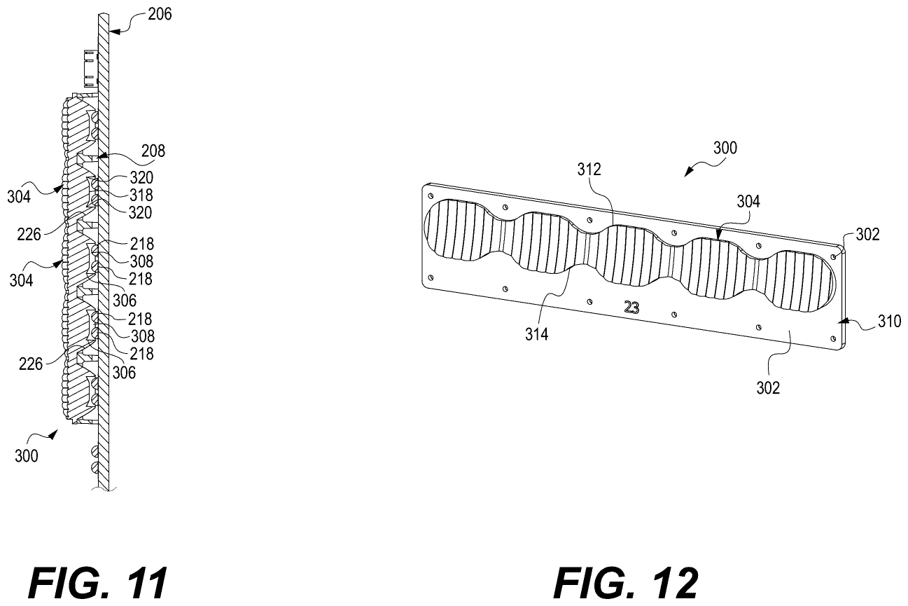

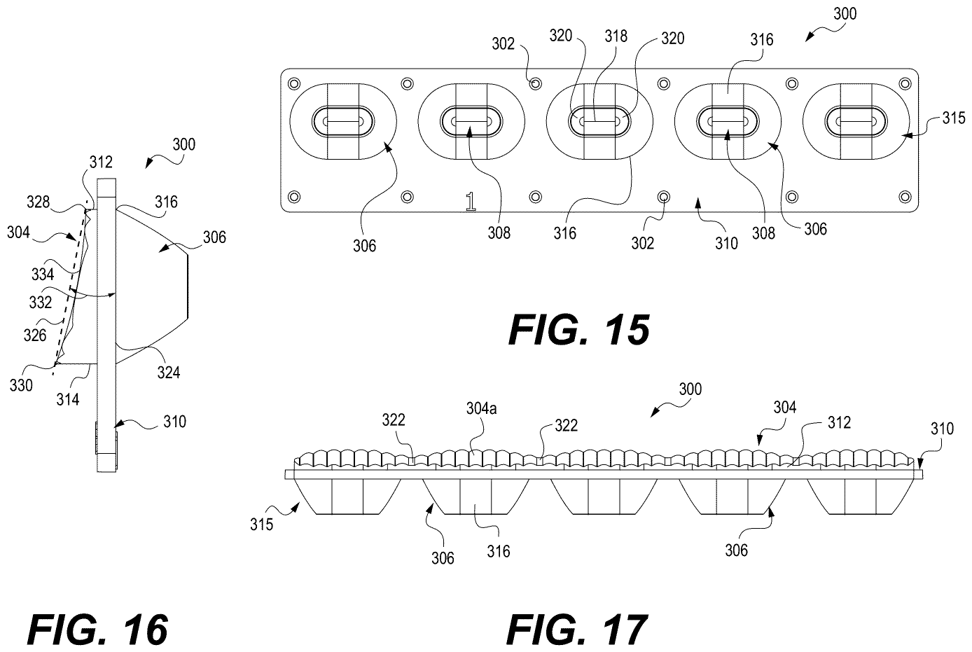

Turning now to FIG. 11, it can be seen that the optics member 300 may include a plurality of forward lens portions 304 that are disposed in front each of the plurality of paired LEDs 218. In addition, the optics member 300 may include a plurality of rearward cones 306 each defining an elongated cavity 308 (see also FIGS. 14 and 15) that is configured to receive one of the plurality of paired LEDs 218. The perimeter of the cones 306 may fit into the (being complementarily shaped) into the lens receiving apertures 226.

The optics member 300 that may be provided as a replacement part will now be discussed with reference to FIG. 12 thru 18. The optics member 300 may have a center plate portion 310, and a forward lens portion(s) 304 defining an upper undulating boundary 312 and a lower undulating boundary 314.

As already alluded to, a rearward LED receiving portion 315 may be provided that includes a plurality of cones 306 each defining an elongated cavity 308 for receiving LEDs. Each of the plurality of cones 306 may be at least partially prismatic shaped (e.g., may have angled surfaces 316 that are flat or nearly flat). Also, the elongated cavity is at least partially defined by an elongated floor with a center raised section 318 and two deeper end sections 320 (see also FIG. 11). The transition point between the deeper end section and the center raised section may be aligned with the center of a LED.

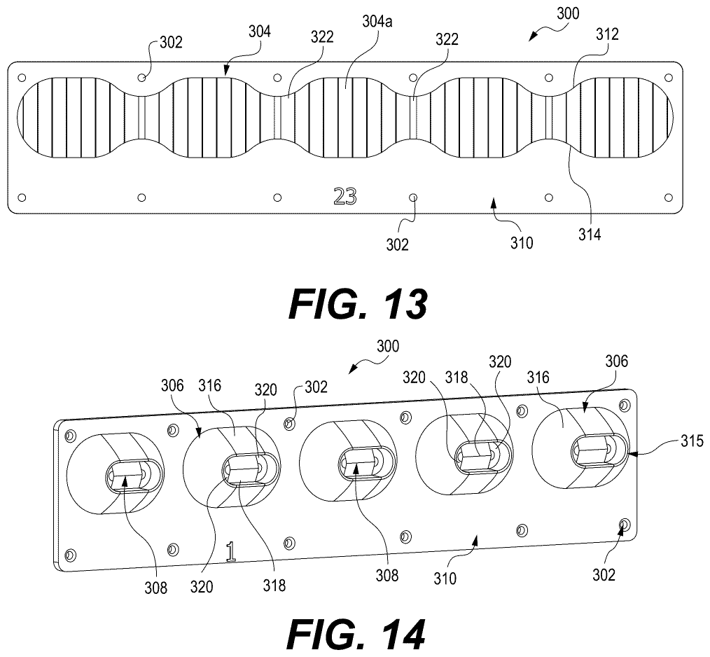

As best seen in FIGS. 13 and 17, the upper undulating boundary 312 and the lower undulating boundary 314 define a plurality of pinched portions 322 that define a pair of sides of a paired LED lens portion 304a disposed forward of one of the plurality of cones 306. This pattern is repeated.

In FIG. 16, the center plate portion 310 may define a flat surface 324, and the forward lens portion 304 may define a line 326 from a topmost point 328 to a bottommost point 330 of the forward lens portion 304 in a plane that is perpendicular to the flat surface 324 (e.g., the plane of FIG. 16), forming an acute angle 332 with the flat surface 324 in that plane. In some embodiments, the acute angle 332 ranges from 5.0 degrees to 15.0 degrees (or more specifically 9.0 degrees to 11.0 degrees or about 10.0 degrees in certain embodiments of the present disclosure).

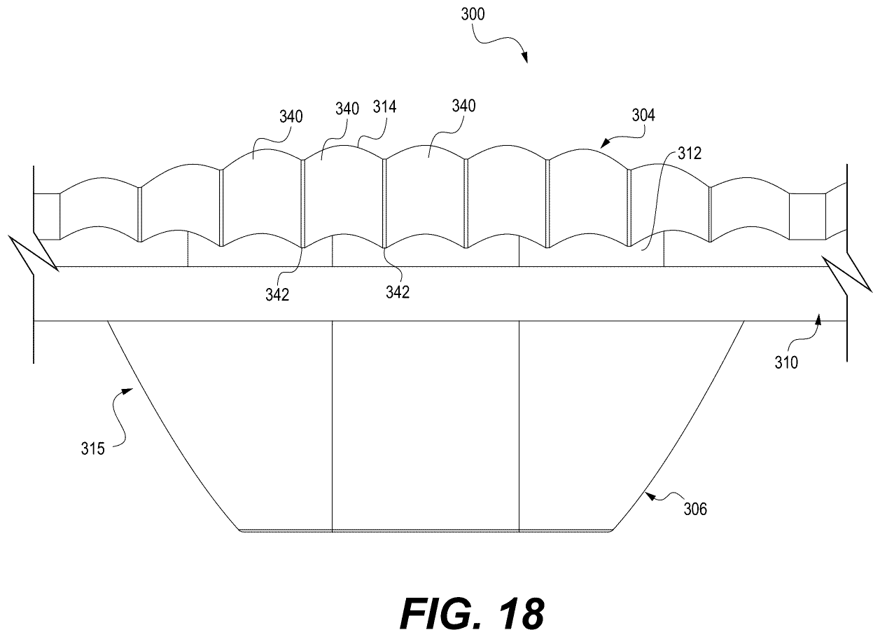

Referring to FIGS. 17 and 18, the forward lens portion 304 includes a forward facing undulating surface 334 (may be referred to as a ripple) defining a higher frequency 336, while the upper undulating boundary 312 or the lower undulating boundary 314 defines a lower frequency 338 than the high frequency 336. As best seen in FIG. 18, the forward facing undulating is made up of a series of convex surfaces 340, and a series of concave surfaces 342 that are smaller in angular extent and radius as compared to the convex surfaces. As seen in FIG. 16, the forward facing undulating surface 334 is convex in the plane that is perpendicular to the flat surface 324 of the center plate portion 310. Other configurations and dimensions are possible in other embodiments of the present disclosure.

It should be noted that the optic member or lens may be used in other applications other than uplighting, and may be made from various materials including glass, acrylate, polystyrene, polycarbonate, silicone, etc.

### INDUSTRIAL APPLICABILITY

In practice, one or more of the following components, assemblies, or subassemblies may be provided initially at the first point of sale in an original equipment manufacturer (OEM) context, or as a replacement part or substitutable part in an aftermarket context: a self-contained luminaire, driver and attachment assembly, a circuit board and heat sink assembly, a loose wiring end bracket, a LED luminaire, and an optic member or lens, etc.

During the retrofitting process or the initial installation, various methods may be employed. For example, if the previous installation lacked an uplight, then a self-contained luminaire, driver and attachment assembly may be attached to a pole or other structural member using sheet metal straps as previously described herein. If the previous system already had an uplight such as shown in FIGS. 1 and 2, then the previous LED luminaire may be disconnected from the adjustable armature or the interface between the adjustable armature and a structural member such as a crossarm (may be both electrically and mechanically disconnected), and a new LED luminaire constructed according to the embodiments discussed herein may be connected (may be both electrically and mechanically) to the adjustable armature or the interface.

Alternatively, or in addition to the these steps, a self-contained luminaire, driver and attachment assembly may be attached to a pole or other structural member using sheet metal straps as previously described herein.

Once installed, the LED luminaire according to an embodiment of the present disclosure may provide suitable uplight (60% or more of the previous luminaire of FIG. 2) at half the wattage and at a reduced initial purchasing cost for the user.

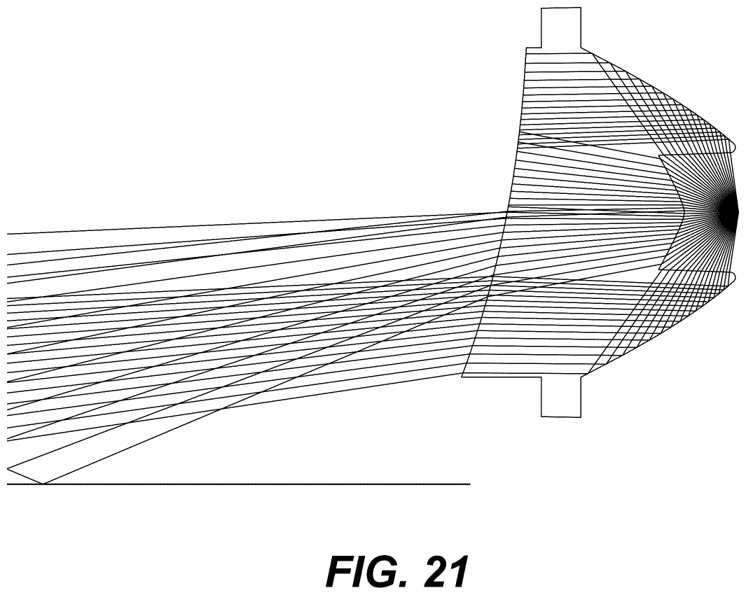

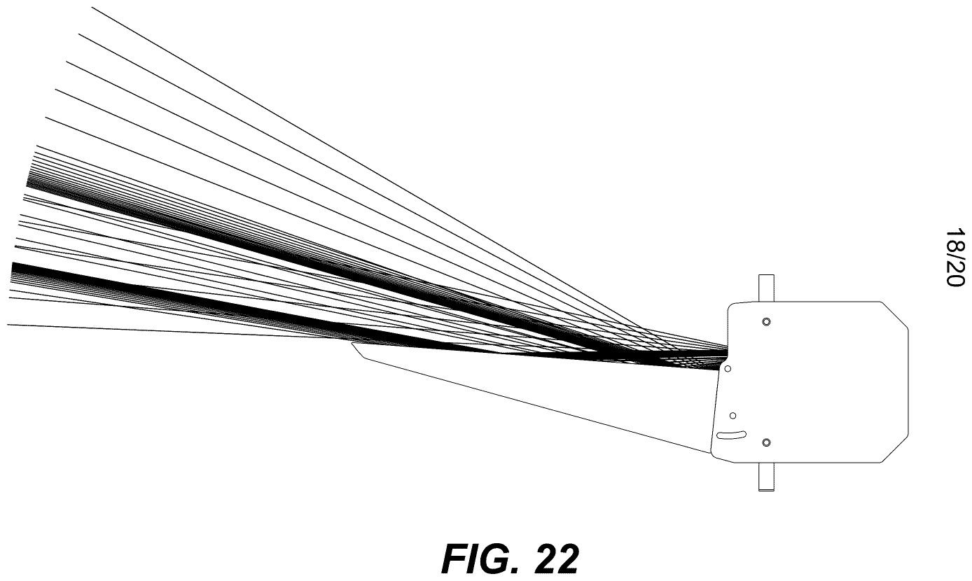

FIG. 21 is a side schematic view showing an optical model of the new optical member, illustrating how it bends refracts light downward toward the reflective visor that reflects the light upwardly, while FIG. 22 is a side view showing more generally how the new optical member bounces light off the reflective visor to provide uplight.

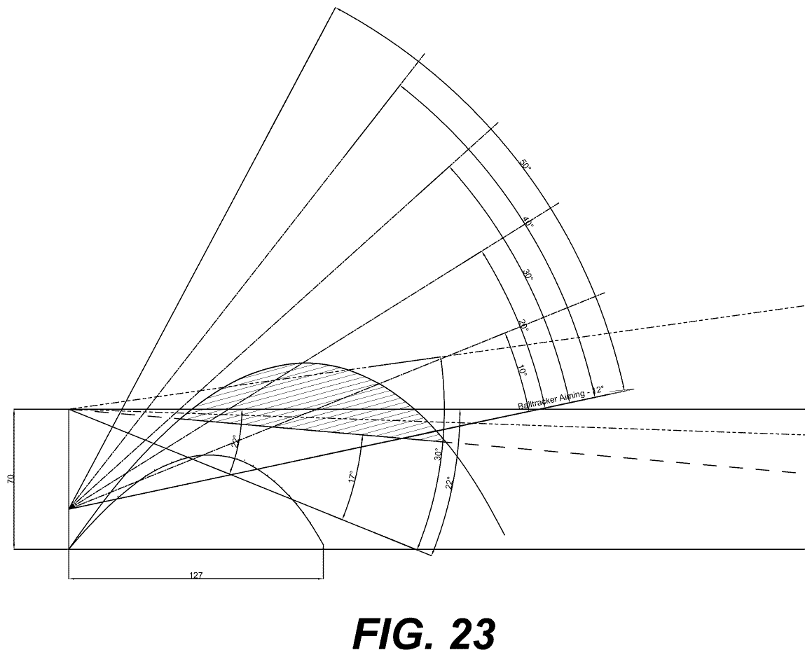

FIG. 23 shows various baseball trajectories indicating that the maximum angle needed for uplight from an uplight luminaire at 25 feet above the ground is about 45.0 degrees from the horizontal plane.

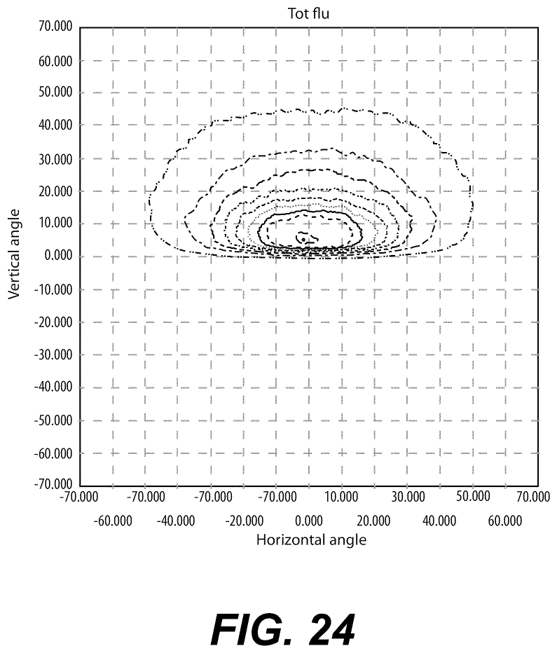

Now that the new optic member refracts the light more effectively to bounce off the reflective visor and the inventors have discovered that less uplight is needed, fewer LEDs are necessary to obtain the desired uplight. As shown in FIG. 24, the horizontal and vertical angles of the dual tipped or angled optical member provide similar performance as the quad optical member with only a slight reduction in horizontal light intensity and slight increase in vertical light intensity. As a result, fewer LEDs are needed, reducing cost, and fewer heat sink fins are needed, further reducing cost.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

Various examples of the disclosure have been described. Any combination of the described systems, operations, or functions is contemplated. These and other examples are within the scope of the following claims.

What is claimed is:

1. A self-contained luminaire, driver, and attachment assembly comprising:
at least a first luminaire;
an attachment beam defining a driver receiving cavity; and
a driver assembly configured to fit within the driver receiving cavity;
wherein the first luminaire comprises a single row of light emitting diodes, and at least a first set of optics that is configured to provide a horizontal spread and a vertical spread of at least a portion of light emitted from the single row of light emitting diodes.

2. The self-contained luminaire, driver, and attachment assembly of claim 1, wherein the attachment beam is a vertical beam that defines a front face that defines the driver receiving cavity.

3. The self-contained luminaire, driver, and attachment assembly of claim 2, further comprising a crossarm that extends perpendicularly to the front face, and the first luminaire is a single luminaire that is disposed in front of the front face.

4. The self-contained luminaire, driver, and attachment assembly of claim 2, further comprising a crossarm that extends along a direction that is parallel to the front face past the front face on a first side, and on a second side.

5. The self-contained luminaire, driver, and attachment assembly of claim 4, wherein the first luminaire is disposed at a first end of the crossarm, and further comprising a second luminaire disposed at a second end of the crossarm.

6. The self-contained luminaire, driver, and attachment assembly of claim 2, further comprising a crossarm attached to the attachment beam, and an adjustable armature connecting the first luminaire to the crossarm.

7. The self-contained luminaire, driver, and attachment assembly of claim 2, wherein the driver assembly includes a front mounting plate that is configured to be mounted to the front face of the vertical beam, a driver attachment plate extending perpendicularly from a rear surface of the front mounting plate, and at least a first driver attached to the driver attachment plate.

8. The self-contained luminaire, driver, and attachment assembly of claim 7, wherein the rear surface defines a seal receiving groove, and further comprising a seal that is disposed in the seal receiving groove.

9. The self-contained luminaire, driver, and attachment assembly of claim 2, further comprising a top plate capping off the vertical beam, and a bottom wire access plate disposed at the bottom of the vertical beam.

10. The self-contained luminaire, driver, and attachment assembly of claim 2, further comprising a top mounting bracket assembly, and a bottom mounting bracket assembly attached to the vertical beam.

11. The self-contained luminaire, driver, and attachment assembly of claim 10, wherein the top mounting bracket assembly, and the bottom mounting bracket assembly are identically configured.

12. The self-contained luminaire, driver, and attachment assembly of claim 10, wherein the bottom mounting bracket assembly includes a top mounting plate including a first mounting ear, and a second mounting ear, and a bottom mounting plate that is identically configured as the top mounting plate.

13. The self-contained luminaire, driver, and attachment assembly of claim 12, wherein the bottom mounting bracket assembly includes a first side U-shaped bracket connecting the top mounting plate to the bottom mounting plate at the first mounting ear, and a second side U-shaped bracket connecting the top mounting plate to the bottom mounting plate at the second mounting ear.

14. A LED luminaire comprising:
a rear fixture plate with a heat sink connected to the rear fixture plate;
a LED board configured to connect to the rear fixture plate;
at least a first optics holder,
at least a first optics member configured to be held adjacent the LED board by the first optics holder;
a window, and
a front frame configured to trap the window, the first optics member, the first optics holder, and LED board adjacent the rear fixture plate;
wherein the LED board includes a single row of LEDs and the heat sink includes a predetermined number of heat sink fins, the LED board includes a predetermined number of LEDs, and a ratio of the predetermined number of LEDs to the predetermined number of heat sink fins ranges from 2.0 to 3.0.

15. A LED luminaire of claim 14, wherein the LED board includes 50 LEDs or less, and the heat sink includes 20 heat fins or less.

16. The LED luminaire of claim 14, wherein the LED board includes a plurality of paired LEDS, that are spaced away from each other by a minimum distance of 0.060 of an inch, and each of the plurality of paired LEDs are spaced away from each other by a maximum distance of 0.518 of an inch.

17. The LED luminaire of claim 14, wherein the optics holder includes a center raised section defining a plurality of lens receiving apertures and a plurality of LED board contacting ribs.

18. The LED luminaire of claim 17, further comprising at least a first lower section configured to be attached to the rear fixture plate.

19. The LED luminaire of claim 17, further comprising a plurality of posts extending forwardly from the center raised section.

20. The LED luminaire of claim 16, wherein the optics member includes a plurality of forward lens portions, and each of the plurality of forward lens portions are disposed in front each of the plurality of paired LEDs.

21. The LED luminaire of claim 20, wherein the optics member includes a plurality of rearward cones each defining an elongated cavity that is configured to receive one of the plurality of paired LEDs.

22. An optics member comprising:
a center plate portion;
a forward lens portion defining an upper undulating boundary and a lower undulating boundary; and
a rearward LED receiving portion including a plurality of cones each defining an elongated cavity;
wherein the forward lens portion is angled away from the center plate portion to redirect light upward relative to the plurality of cones.

23. The optics member of claim 22, wherein the center plate portion defines a plurality of post receiving holes.

24. The optics member of claim 22, wherein each of the plurality of cones is at least partially prismatic shaped.

25. The optics member of claim 22, wherein the elongated cavity is at least partially defined by an elongated floor with a center raised section and two deeper end sections.

26. The optics member of claim 22, wherein the upper undulating boundary and the lower undulating boundary define a plurality of pinched portions that define a pair of sides of a paired LED lens portion disposed forward of one of the plurality of cones.

27. The optics member of claim 22, wherein the center plate portion defines a flat surface, the forward lens portion defines a topmost point, a bottommost point and a line connecting the topmost point to the bottommost point in a plane that is perpendicular to the flat surface, forming an acute angle with the flat surface.

28. The optics member of claim 27, wherein the acute angle ranges from 5.0 degrees to 15.0 degrees.

29. The optics member of claim 28, wherein the acute angle ranges from 9.0 degrees to 11.0 degrees. 29a. The optics member of claim 29, wherein the acute angle is about 10.0 degrees +/−0.25 degrees.

30. The optics member of claim 27, wherein the forward lens portion includes a forward facing undulating surface defining a higher frequency, and the upper undulating boundary or the lower undulating boundary defines a lower frequency than the higher frequency.

31. The optics member of claim 30, wherein the forward facing undulating surface is convex in the plane that is perpendicular to the flat surface.

32. The optics member of claim 30, wherein the forward facing undulating surface comprises a series of convex surfaces, and a series of concave surfaces that are smaller than convex surfaces.
